(19) United States
(12) Patent Application Publication
(10) Pub. No.: US 2023/0169276 A1
(43) Pub. Date: Jun. 1, 2023

(54) SWITCHBOARD

(71) Applicant: THE NEW YORK TIMES COMPANY, New York, NY (US)

(72) Inventor: John Buhler COOK, New York, NY (US)

(73) Assignee: THE NEW YORK TIMES COMPANY, New York, NY (US)

(21) Appl. No.: 18/056,233

(22) Filed: Nov. 16, 2022

Related U.S. Application Data
(60) Provisional application No. 63/284,966, filed on Dec. 1, 2021.

(51) Int. Cl. G06F 40/40; G06N 5/02

(52) U.S. Cl. CPC G06F 40/40; G06N 5/022

(57) ABSTRACT

According to one embodiment, a computer-implemented method for clustering and answering questions is provided. The method includes obtaining an input from a user device, wherein the input comprises a text. The method includes transforming, using a first natural language processing model, the text into a first embedding vector representing a location in an embedding graph, wherein the embedding graph comprises a plurality of prior question embedding vectors representing respective locations in the embedding graph and each prior question embedding vector is associated with at least one answer text. The method includes selecting a set of one or more prior question embedding vectors based on a distance in the embedding graph between the location of the first embedding vector and the respective locations of the plurality of prior question embedding vectors. The method includes, for each respective prior question embedding vector in the selected set of one or more prior question embedding vectors, generating, using a zero-shot confidence scoring model, a respective confidence score value for the respective prior question embedding vector, wherein the respective confidence score value corresponds to a degree of similarity between the first embedding vector and the respective prior question embedding vector. The method includes selecting a first prior question embedding vector from the selected set of one or more prior question embedding vectors based on the generated respective confidence score value of the first prior question embedding vector. The method includes obtaining an answer text associated with the first prior question embedding vector. The method includes generating a response comprising the identified answer text.

### CROSS-REFERENCE TO RELATED APPLICATIONS

This application is a non-provisional of, and claims the priority benefit of, U.S. Prov. Pat. App. No. 63/284,966 filed Dec. 1, 2021, which is hereby incorporated by reference in its entirety.

### TECHNICAL FIELD

Aspects of the present disclosure relate to the fields of machine learning and natural language processing. In particular, the present disclosure relates to the use of natural language processing models to understand and cluster text.

### BACKGROUND

Currently, readers often turn to search engines when they have a question about the news. Answers found there are not always accurate, and are subject to the search providers' opaque business objectives and operations.

Presently, artificial intelligence (AI) technology can be used to identify answers for a user's question. Often this task is completed utilizing a form of AI called natural language processing (NLP), which may leverage one or more machine learning models. Such models are trained to identify and cluster questions using training data sets. A training data set may provide a NLP model with a series of questions and correct classes for the questions, and the NLP model may be used to cluster the questions based on semantic similarity. The model will create a representation of questions (e.g., a question embedding), typically in the form of a vector in space, which are used to cluster questions together based on their proximity of vectors. The training data may be leveraged by the model to learn the correct rules for clustering questions.

One technique for pre-training a NLP model is called Bidirectional Encoder Representations from Transformers (BERT). [1, 2]. BERT is a deeply bidirectional, unsupervised language representation, pretrained using a plain text corpus.

Another learning technique is called Zero-shot learning, where the classes covered by training instances in the training data and the classes the model aims to classify are disjoint. [3, 4]. In Zero-shot learning, a model can classify data on the fly based on very few or even no labeled training data examples.

### SUMMARY

While useful, there are issues that commonly arise from existing NLP methods for clustering questions.

For example, one problem that arises is that many NLP models rely on training sets to learn how to properly map inputs to classes. In the case of answering questions, the models learn to cluster semantically similar questions together with appropriate answers. There are a number of downsides in relying on training data sets, including that it can be quite time consuming to collect and prepare appropriate training data, there may be restrictions on available training datasets, and the training data may be inaccurate or introduce biases into the model.

Another problem with traditional NLP models is that they can be difficult to update in real time. For example, much of the information may become outdated and need to be replaced, particularly for breaking news and developing events. For example, a user may desire to ask questions about an event currently occurring, like an ongoing natural disaster, where information about the event may be changing rapidly in real-time.

Another problem that traditional models may run into is limited data sources. Traditional models may be unable to access multiple data sources when seeking to answer a question, and may in many cases be limited to the data sources that it was trained to utilize.

Aspects of the present disclosure provide an improved dynamic system called Switchboard that takes in questions live and surfaces answers (when they exist). If there are no existing answers, it creates a dynamic queue that factors in reader interest for editors to answer. Certain approaches also use a different underlying approach for the model (called zero-shot learning) that is more accurate and flexible. The zero-shot learning approach allows for Switchboard to be more modular and flexible in the kinds of data it can surface for readers and for Switchboard to be used for multiple projects in different domains at the same time.

According to one aspect, a computer-implemented method for clustering and answering questions is provided. The method includes obtaining an input from a user device, wherein the input comprises a text. The method includes transforming, using a first natural language processing model, the text into a first embedding vector representing a location in an embedding graph, wherein the embedding graph comprises a plurality of prior question embedding vectors representing respective locations in the embedding graph and each prior question embedding vector is associated with at least one answer text. The method includes selecting a set of one or more prior question embedding vectors based on a distance in the embedding graph between the location of the first embedding vector and the respective locations of the plurality of prior question embedding vectors. The method includes, for each respective prior question embedding vector in the selected set of one or more prior question embedding vectors, generating, using a zero-shot confidence scoring model, a respective confidence score value for the respective prior question embedding vector, wherein the respective confidence score value corresponds to a degree of similarity between the first embedding vector and the respective prior question embedding vector. The method includes selecting a first prior question embedding vector from the selected set of one or more prior question embedding vectors based on the generated respective confidence score value of the first prior question embedding vector. The method includes obtaining an answer text associated with the first prior question embedding vector. The method includes generating a response comprising the identified answer text.

In another aspect there is provided a device adapted to perform the method. In another aspect there is provided a computer program comprising instructions which when executed by processing circuitry of a device causes the device to perform the methods.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is a block diagram, according to some embodiments.

FIG. 2 is a flow diagram, according to some embodiments.

FIG. 3 is a screen capture of a user interface, according to some embodiments.

FIGS. 4A-B are a screen capture of a user interface, according to some embodiments.

FIG. 5 is a method, according to some embodiments.

FIG. 6 is a block diagram illustrating a device, according to some embodiments.

### DETAILED DESCRIPTION

Aspects of the present disclosure relate to a first-of-its-kind application of zero-shot learning for an applied machine learning (ML) interactive for clustering and answering questions called Switchboard. This approach allows for Switchboard to be more modular and flexible in the kinds of data it can surface for readers and for Switchboard to be used for multiple projects in different domains at the same time.

The present disclosure describes several key improvements, including, inter alia, the use of a modular backend, applications of zero-shot learning, human-in-the-loop tuning for sensitive questions, easy-to-use dashboard and applications for live coverage. These improvements offer a number of technological advantages over existing systems. For example, the application of zero-shot learning reduces training-time and use of training data, while simultaneously improving the accuracy of the system in appropriately clustering similar reader questions. In addition, zero-shot learning allows for customizable definitions of similarity, interchanging of natural language processing models, and interchanging of languages (e.g., French to English) used in the Switchboard system. Zero-shot learning can also allow for the Switchboard system to have different launches that are configured to receive different prompts (e.g. live vs FAQ). The different prompts enable one to define what “similarity” means when comparing two inputs. For example, “similarity” could mean whether two questions are asking the same thing. But, if for example, the system is clustering questions about food, zero-shot learning may be used to instead specify that “similarity” means that the foods discussed in each contain the same ingredient—all without additional training data. Additionally, the techniques described herein further improve the accuracy of the system in processing questions in sensitive subject domains that may have subtle semantic nuances.

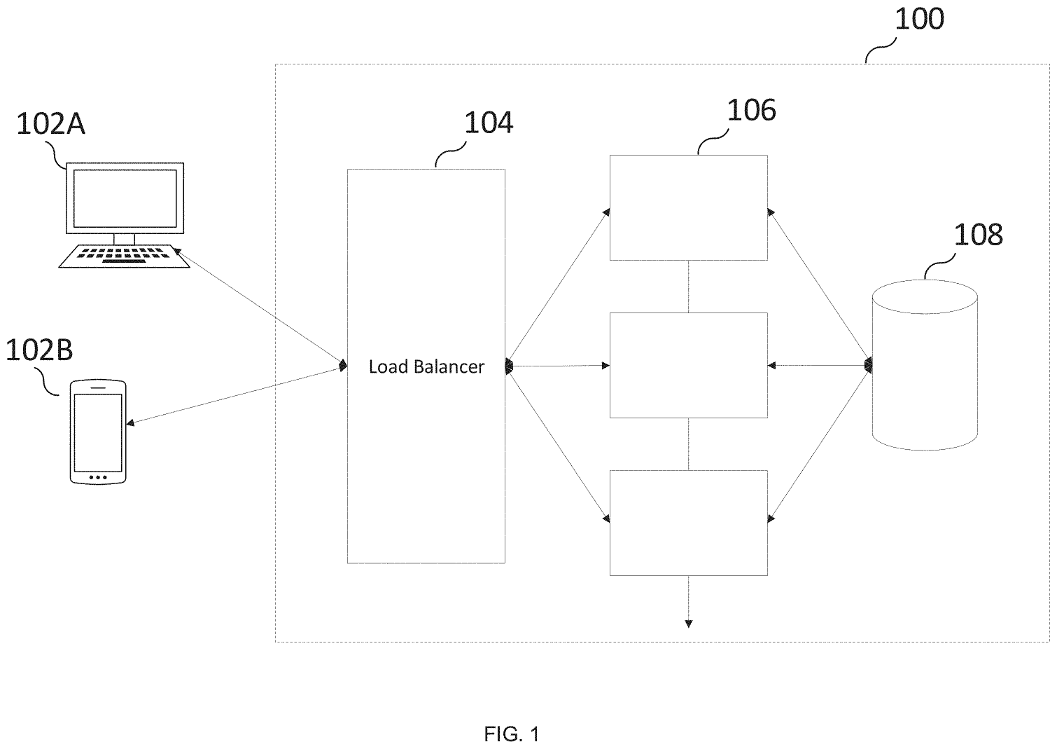

FIG. 1 is a block diagram, according to some embodiments. In some embodiments, FIG. 1 illustrates a System 100 for automatically clustering and providing answers to user's questions. One or more users operating User Devices 102A-B may desire to transmit a question to the system 100. The User Devices 102A-B may be an electronic computing device, such as a mobile device, laptop, computer, desktop, tablet, and the like, capable of communication with one or more other devices through a network such as the Internet. The User Devices 102A-B may transmit an input question to the Switchboard System 100 via a web or mobile application. The web application may contain a graphical display that allows users to enter and transmit the question to the Switchboard System 100.

The Switchboard System 100 may include a Load Balancer 104, a Modular Backend 106, and one or more Databases 108. In some embodiments, these components are co-located on the same device. In other embodiments, one or more of these components may be dispersed among one or more computing devices or servers, e.g., in a cloud-based and/or virtual environment. The question may be transmitted to a Load Balancer 104. In some embodiments, the Load Balancer 104 may be a physical device. The Load Balancer 104 may include software for implementing the Load Balancer 104. In other embodiments, the Load Balancer 104 may be virtualized and running on a virtual machine.

The Load Balancer 104 may control the flow of information being received from and transmitted to the User Devices 102A-B. The Load Balancer 104 may transmit the requests received from User Devices 102A-B, such as an input question, to the Modular Backend 106. The Modular Backend 106 may be on the data access layer. The Modular Backend 106 may comprise a series of one or more servers. In some embodiments, the one or more servers may consist of virtual servers. The Load Balancer 104 may be able to increase the number of servers operating within the Modular Backend 106 when there is an increase data traffic in questions received from one or more users. The Load Balancer 104 may also be able to decrease the number of servers on the Modular Backend 106 when there is a decrease in data traffic in questions received from one or more users. The Load Balancer 104 may be able to communicate with each sever comprising the Modular Backend 106.

Each server within the Modular Backend 106 may host the software and NLP models described herein. Each server may also host a question index. The question index may contain previously answered questions.

The Modular Backend servers 106 may be in communication with one or more Databases 108. In some embodiments, Database 108 is a Redis database. In some embodiments, the Database 108 may be co-located with the Modular Backend servers 106, or may be located elsewhere. The Database 108 may contain one or more data sources comprising a series of questions that have been answered. In some embodiments, the answered questions may have been embedded into vectors representing locations within the embedded graph. In some embodiments, the Database 108 facilitates communication between and among the Modular Backend servers 106 so that the servers can stay in sync in response to events that require coordination, such as processing of new questions and/or new answers. In some embodiments, the Modular Backend servers 106 may be in communication with one or more external data sources. For example, such external data sources may include Google's Data QnA for quantitative questions, or another module.

In prior approaches, the backend server was relatively static. Making changes required updates to the backend servers, answers could only be pulled from one knowledgebase, and the entire system could only be enabled or disabled all at once. According to aspects of the present disclosure, different modules can be added and rearranged from an internal dashboard, answers can come from many different data sources, and modules can be turned on or off independently.

There may be two types of modules deployed on the Modular Backend 106: filters and actors.

The Switchboard model may utilize a filter module to determine whether or not a question should be answered or ignored. The filters used by the Switchboard model may range in complexity. In some embodiments, filters may utilize a banned word list to filter out any question using profanity. In other embodiments, a filter may utilize machine learning to filter out questions. In further embodiments, the filter may use machine learning to generate some relevancy value for a user question. If the user question falls below some threshold, then the question may not be relevant and may be filtered out. In other embodiments, a filter may utilize a form of machine learning such as Perspective API. The Perspective API may generate an appropriateness rating for the user questions. The appropriateness rating may filter not just for relevancy, but also for toxicity or crudeness. For example, a user question such as “Why is Tom Hanks so dumb?” might be considered too crude by the filter utilizing Perspective API. The question would then be filtered out.

The Modular Backend 106 may utilize an actor module that provides answers to questions that have passed all filters. The actor module may leverage one or more databases which may be, for example, an internal database (e.g., an internal core knowledgebase with answers submitted by reporters and experts), or an external database from a third-party such as Google's Data QnA.

In some embodiments, custom actors and filters may be defined by users, such as editors moderators, and/or authors.

Each Modular Backend server 106 may utilize natural processing language model to embed the received user question into vectors representing a location in an embedding graph. The Switchboard model may then utilize the question index to discover prior embedded questions vectors representing locations in the graph. Each server containing the Switchboard model may then use an actor module to send a request to the one or more internal or external databases to obtain an answer to one or more previously answered questions.

A user may also have a role such as a moderator/author. A moderator and/or author may also use User Devices 102A-B to connect to a server on the Modular Backend 106 through the Load Balancer 104. The moderator/author may utilize a user interface to interact with the Modular Backend 106. The moderator/author utilizing this user interface may be able to see the questions that have been clustered together on Modular Backend server 106. The moderator/author may be able to edit the answers for the clustered questions in the Modular Backend server 106. In cases where a question has not been mapped with an answer, a moderator/author may be able to provide an answer to a question. The moderator/author may also be able to add a question to a cluster, remove a question from a cluster, or change the cluster that a question is in.

The Switchboard server may transmit the updated mapping of questions and answers to the Database 108 and also update the search index to include the updated questions and answers. The Switchboard servers may utilize the search index and the Database 108 to ensure that future user questions are mapped according to the updated data.

The Modular Backend 106 may then transmit the user question and its corresponding answer to the Load Balancer 104. The Load Balancer 104 may then transmit the question and answer paring to the User Devices 102A-B. The User Devices 102A-B may use a graphical display to show the user the answers.

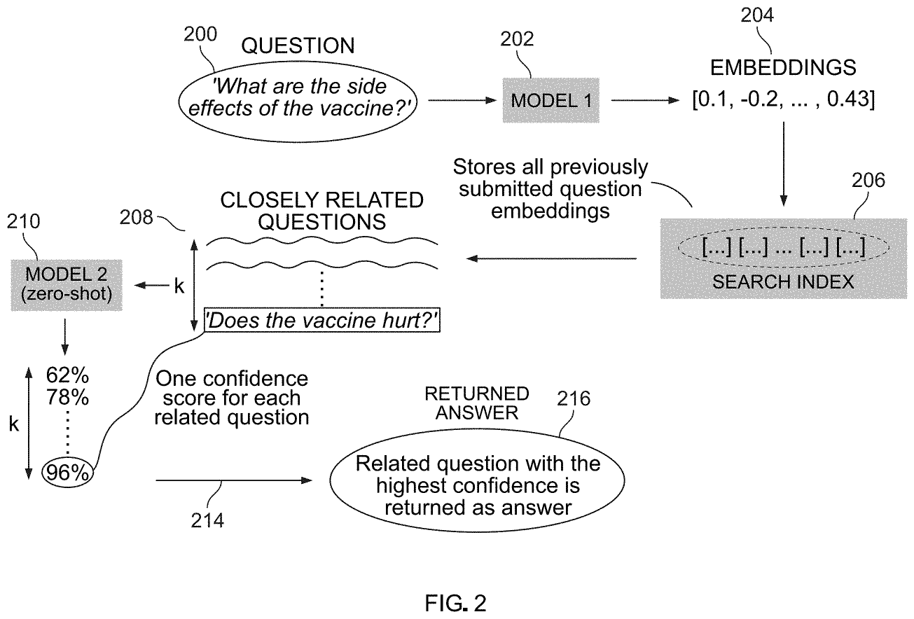

FIG. 2 is a flow diagram, according to some embodiments. In some embodiments, FIG. 2 illustrates the logical flow for the Switchboard system providing an answer to a user's question

At 200, the system (e.g., System 100) may obtain a question, e.g., from a User Device 102A-B (a “User Question”), which may include text.

At 202, the system processes the User Question using a first ML model, Model 1. In some embodiments, Model 1 may be a Bidirectional Encode Representations from Transformers (BERT) model. In some embodiments, Model 1 may leverage a Transformers library [5] to train and evaluate language models. In some embodiments, Model 1 may be trained using one or more sets of documents, or a corpus of documents.

At 204, Model 1 transforms the User Question into one or more question embeddings. In some embodiments, the question embeddings include one or more values. In some embodiments, the question embeddings may include hundreds of values, e.g., 384 or 768. In some embodiments, Model 1 may embed questions by sequentially generating values for each word in a question. The Model 1 may start sequentially embedding words starting at the first word on the left of a question or starting at the first word on the right of a question. In other embodiments, Model 1 may embed questions by generating values for the entire sequence of words at once, using bidirectional embedding. Model 1 may use such bidirectional embedding when, for example, utilizing the BERT model as its natural language processing model. The values represent a location within an embedded graph. In some embodiments, the question embeddings are full sentence embeddings generated using Sentence-BERT, which uses siamese and triplet network structures to derive semantically meaningful sentence embeddings. [7].

At 206, the embeddings of the User Question are compared against a question or search index. The search index may contain all previously submitted questions that are stored in embedded form. In some embodiments, the search index comprises an embedded graph comprising a plurality of nodes corresponding to question embedding representations of previously answer questions. Previously asked questions may be linked together into clusters using NLP clustering techniques based on a proximity of the previously asked questions in the embedded graph. In some embodiments, one or more nodes in the cluster corresponding to a previously asked question may be associated with, or linked to, an answer from one or more data sources.

In some embodiments, a cluster may contain one or more central questions and one or more new questions (e.g., asked by a user) that are all linked directly or indirectly (via one or more additional nodes) to a central question based on their proximity in the embedded graph. The central questions may be key questions authored by a journalist or expert in a topic area, and in some embodiments, the key questions may be linked to an answer authored by a journalist or expert.

At 208, the system identifies prior questions in the search index that are closely related to the User Question. In some embodiments, the system may identify whether the User Question embedding representation is within a certain proximity to other questions within the embedded graph. The User Question may be clustered with a question it is in closest proximity to in the embedded graph. In some embodiments, the questions within the search index may be grouped into a series of one or more clusters based on their proximity to each other within the embedded graph. In some embodiments, particularly where the clusters contain a large number of previously asked questions, the system may compare the User Question to a subset of the nearest questions in a cluster. In some embodiments, the system outputs a predetermined number (“k”) of previously submitted questions from the search index that are closest in proximity to the User Question.

At 210, a second ML model, Model 2, is used to predict a confidence score that the User Question is closely related to the one or more (k) prior questions identified by the first model at 208. According to some embodiments, Model 2 may be trained to predict the confidence score based on zero-shot learning. Zero-shot learning combines known classes from data training to unknown data classes that have not been trained. Zero-shot learning is able to accomplish the learning task by having an additional unrelated knowledge base about characteristics of some classes. In some embodiments, Model 2 is trained using the Stanford NLI Corpus. [6].

At 214, Model 2 outputs confidence scores reflecting whether the User Question is closely related to each of the k related questions.

At 216, the system identifies the related question for which Model 2 generates the highest confidence score, which will be returned as the answer. In some embodiments, the confidence score may also factor in the probability that the User Question is properly grouped to a center question in a cluster based on it being mapped to a branch question. In some embodiments, Model 1 may provide some probability reflecting a likelihood that each branch question is the same question as the central question that has been answered.

In some embodiments, once the related question with the highest confidence is returned, the system identifies an answer associated with the related question, and returns the answer to the user that submitted the question. In other embodiments, none of the related questions may have a confidence score that is above some threshold, in which case the system may return no answer.

In one example, the system was configured to answer questions from users pertaining to Covid-19 vaccines. A user may transmit a User Question “What are the side effects of the vaccine?” The first ML model embeds the User Question into a representation (e.g., one or more question embeddings comprising values) representing a location within an embedded graph. The values will be compared to all or a subset of prior question that have been embedded into vectors in the search index. The User Question may be grouped with a predetermined number k (e.g., 10) closely related question or questions that are in the nearest proximity to the User Question in the search index. In this example, one identified closely related question may be “Does the vaccine hurt?”. The question “Does the vaccine hurt?” may be correlated with an already submitted answer “Vaccines may cause slight flu-like symptoms.” Another closely related question may be identified, such as “Where can I get my vaccine?”, In this case, the first model may identify both questions “Does the vaccine hurt?” and “Where can I get my vaccine?” in the search index as being closely related to the User Question.

The second model, Model 2, which utilizes zero-shot learning will generate a confidence score reflected whether each identified related question in the search index is closely related to the User Question. The second Model 2 may generate a confidence score of 80% that the User Question and the question “Does the vaccine hurt?” are closely related, while generating a 60% confidence score that the User Question is correctly mapped to the question “Where can I get my vaccine?” Because the question “Does the vaccine hurt?” has the higher confidence value, the system will return the answer mapped to the question. Thus, the system will provide the Answer “Vaccines may cause slight flu like symptoms” to the User Question “What are the side effects of the vaccine?” In some embodiments, an answer may not be returned if the confidence value is below a certain threshold, such as 50%.

In practice, the addition of the second model to generate a confidence score has resulted in higher accuracy of the system in correctly identifying closely related questions as compared to simply using the first model. Moreover, the application of zero-shot learning techniques for the second model has resulted in further improvements to the accuracy of the system.

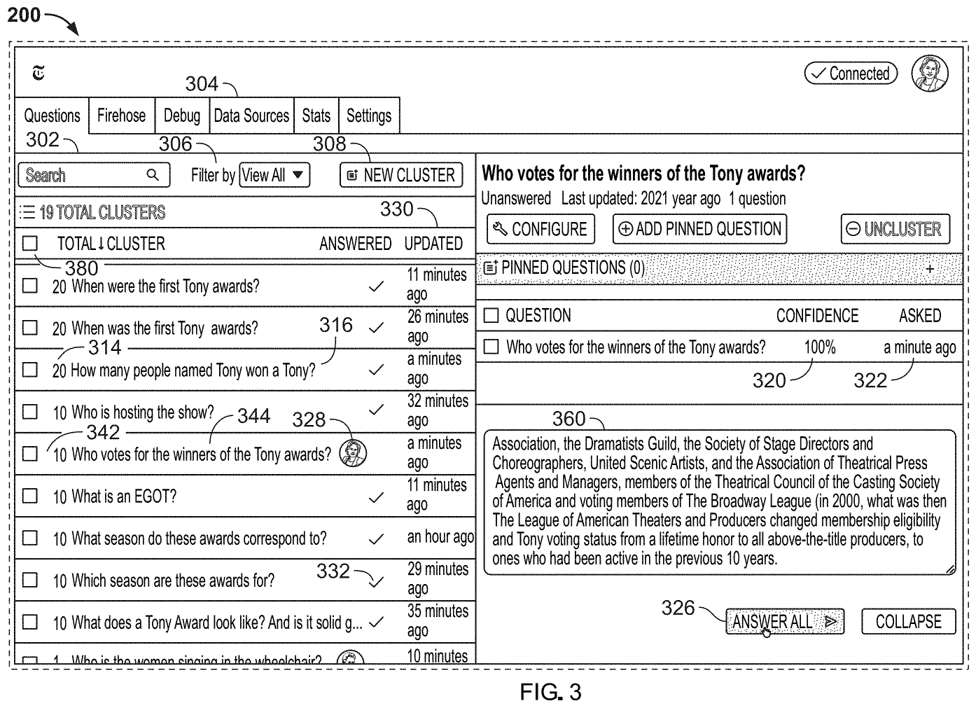

FIG. 3 is a screen capture of a user interface, according to some embodiments.

The User Interface 300 may be utilized to allow a moderator (e.g., a reporter) to input answers to questions within the model and adjust the search index and clustering of previous questions, among other features. The User Interface 300 may display clusters of questions that have been asked. The questions may be placed into clusters based on applying a natural language processing model as described above. In some embodiments, a zero-shot learning model may be applied in addition to generate a confidence value as to whether questions are closely related. The User Interface 300 may display the number of questions within a cluster. In addition, the User Interface 300 may also display whether the cluster of questions has an answer. The User Interface 300 may contain a Search Bar 302 that allows the moderator to search for clusters of questions. The moderator may be able to filter for questions using a Filter Bar 306. In some embodiments, the questions may be received in real-time. The moderator may be able to provide updates and answers to the questions in real-time. A moderator may be able to click on a cluster of questions shown in the User Interface 300 in order to see the current answer for that particular cluster of questions. The moderator may be able to either change the answer to the cluster of questions, or if there is no answer, provide an answer to the cluster of questions. The User Interface 300 may also display how recently an answer to a cluster of questions has been updated. In some embodiments, the User Interface 300 may be utilized by more than one moderator. The User Interface 300 may thus display which moderators are answering modifying or providing answers for which questions. Thus, two moderators are prevented from attempting to either modify or provide an answer to a cluster of questions at the same time.

For example, the system may be utilized to provide real-time updates and answers to user generated question about the Tony awards. A moderator may use the User Interface 300 to provide real-time answers to user's questions. The User Interface 300 may display a Chart 380 containing clusters of questions about the Tony awards that have been submitted in real-time by users. The questions may be clustered together using a natural language processing model as described above. In some embodiments, an additional zero-shot learning model may be used to generate a confidence value that each question is appropriately clustered with related questions. Each row in the Chart 380 may display a cluster of questions. The number on the side of the rows such as Number 314 may denote the number of questions in a cluster. In this example, the Question 316 “How many people named Tony won a Tony?” is the main question for a cluster containing twenty questions. Thus, the answer that is matched to the Question 316 will be the answer for the cluster.

The User Interface 300 may also display to moderator which questions have been answered. Green check marks such as the Green Check Mark 332 may denote to the moderator that a question has been answered. A question that has been unanswered may be able to be selected by the moderator. Row 342, has the Question 344 “Who votes for the winners of the Tony awards?”. A moderator may click on the Question 344 in order to answer the question. An Icon 328 of the moderator may appear next to the row of the question being answered. This enables a second moderator to know that the question is currently being answered, preventing two moderators from answers the same question at the same time. To the right of a question, the Updated Column 330, shows a moderator who has recently provided an answer to a specific cluster. The Answer Box 360 may allow the moderator to input the answer for the selected question. Above the Answer Box 360, the User Interface 300 may display the Confidence Value 320 that a question is correctly clustered. In this example, the moderator is inputting an answer for the Question 344 “Who votes for the winners of the Tony awards?”. The Confidence Value 320 is 100% since it has been reviewed by a human moderator. The User Interface may also display to the moderator when the selected question was last asked by a user or updated via Time Bar 322. The moderator may submit the answer by hitting the button Answer All 326. The provided answer may then be mapped to the answer cluster.

The User Interface 300 may also allow a moderator to edit or change a particular cluster of questions. A moderator may be able to remove a question from a cluster of questions, create a new cluster of questions, or move a question from one cluster of questions to another. The moderators may take these actions to account for questions that are incorrectly grouped. The User Interface 300 may be so connected to the Modular Backend 106 that it is able to update and train its models based on the changes in clustered questions provided by a moderator. This allows the system to update and learn from the choices made by a moderator so that the model does not continue to incorrectly group related questions.

For example, a moderator may select a question and click on the button New Cluster 308 to generate a new cluster for a question. The moderator may also control which data sources are being used by Switchboard to answer questions via the User Interface 300. The moderator may select the Data Sources Tab 304 to view and select which data sources may be used by the system to answer questions. In some embodiments, this tab may be used to create new actors for the system, as discussed above.

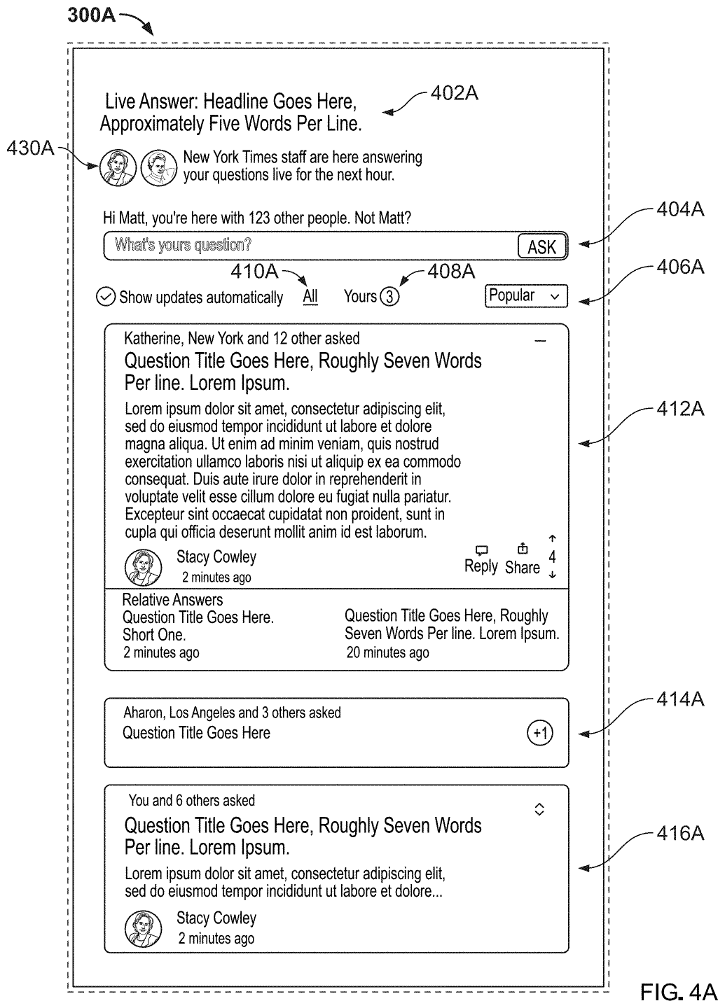

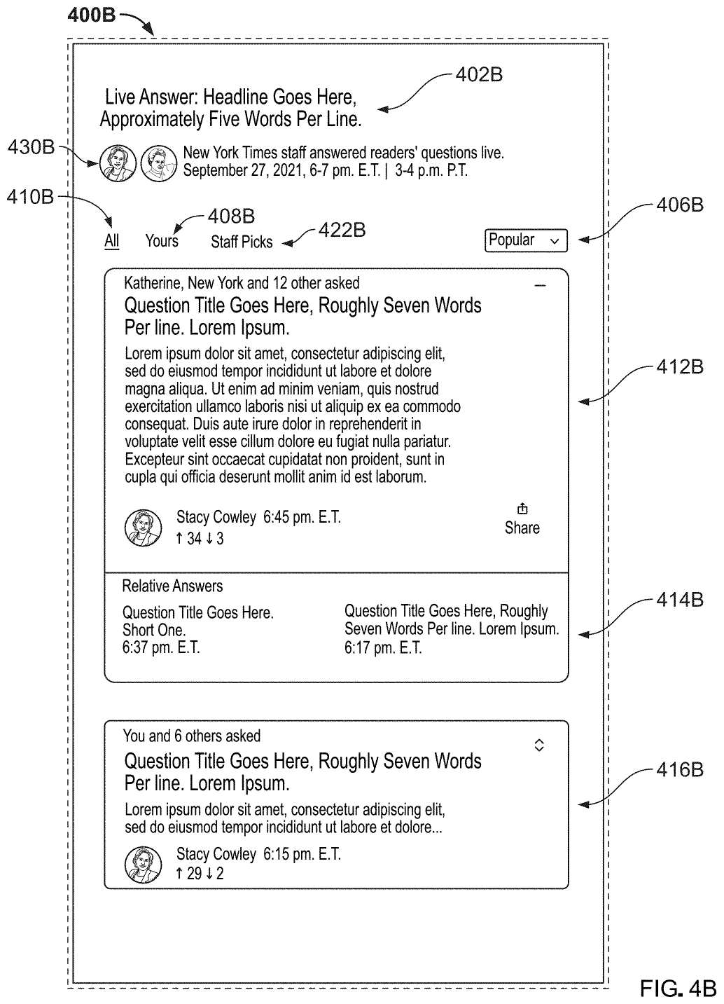

FIGS. 4A-B are screen captures of a user interface, according to some embodiments.

A user may use a User Interface 400A to ask the system questions and view answers to the questions. The User Interface 400A may display a Title 402A. The Title 402A may relate to the topic for which the system is receiving and answering questions. The user interface may be configured to allow the user to submit answers via an Ask Bar 404A. The User Interface 400A may display already asked and answered questions in Boxes 412A, 414A, 416A. The User Interface 400A may further allow the user to filter for what questions and answers are shown. The user may filter for click on the button All 410A to have the user interface display all questions that have been answered. The user may be able to click on the button Yours 408A to display only the questions and subsequent answers asked by the user. In some embodiments, the questions will be answered by moderators. The moderators providing the answers may be displayed at Photo 430A.

FIG. 4B shows another embodiment of the User Interface 400B. In this embodiment, a user may be able to click on the button Staff Picks 422B to see what questions the staff has designated as most important. This embodiment may be used before, during, or after a live event. A user may also filter questions by clicking on the Bar 406B. The Bar 406B may allow a user to select what questions are most popular. In another embodiment, the Bar 406B may allow the user to select what questions are currently trending.

In some embodiments, the moderators may be answering questions asked by users in real time.

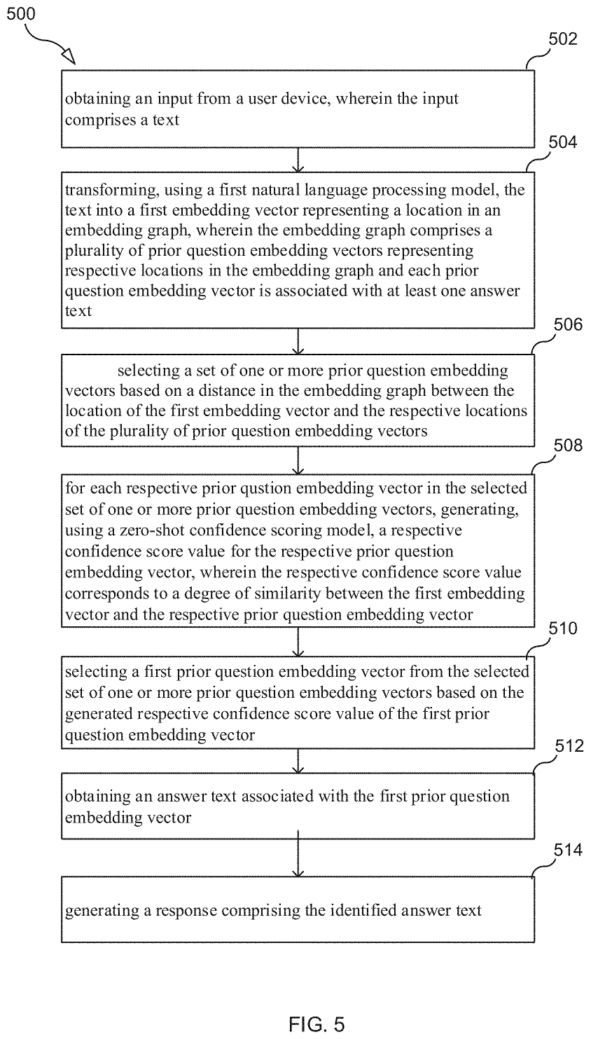

FIG. 5 is a method, according to some embodiments. The method 500 involves a series of steps that may be performed by System 100. In some embodiments, method 500 is a computer-implemented method for clustering and answering questions.

Step 502 includes obtaining an input from a user device, wherein the input comprises a text. The user device may comprise a phone, computer or other network compatible device, such as User Devices 102A-B discussed above. The user input may comprise a string of text from the user. The text may pertain to a question that the user is asking. The user may input the text of the question by using a user interface, such as one of the user interfaces shown in FIGS. 4A-4B. The user interface may be configured to display the topic of which the user can ask questions as well as contain a section for the user to input his or her questions. In some embodiments, the user interface may also display previous questions that have been asked, either by the current user or previous users.

Step 504 includes transforming, using a first natural language processing model, the text into a first embedding vector representing a location in an embedding graph. In some embodiments, the embedding graph comprises a plurality of prior question embedding vectors representing respective locations in the embedding graph and each prior question embedding vector is associated with at least one answer text. In some embodiments, the first natural language processing model may be Model 1 discussed above in connection with FIG. 2.

Step 506 includes selecting a set of one or more prior question embedding vectors based on a distance in the embedding graph between the location of the first embedding vector and the respective locations of the plurality of prior question embedding vectors. The set of prior question embedding vectors may be selected for having the shortest distance from the first embedding vector within the embedding vector graph. The set of prior question embedding vectors may comprise one or more questions.

Step 508 includes, for each respective prior question embedding vector in the selected set of one or more prior question embedding vectors, generating, using a zero-shot confidence scoring model, a respective confidence score value for the respective prior question embedding vector, wherein the respective confidence score value corresponds to a degree of similarity between the first embedding vector and the respective prior question embedding vector. In some embodiments, the zero-shot confidence scoring model may be Model 2 discussed above.

Step 510 includes selecting a first prior question embedding vector from the selected set of one or more prior question embedding vectors based on the generated respective confidence score value of the first prior question embedding vector. As discussed above, the system may select the first prior question embedding vector from the set of prior question embedding vectors based on the first prior question embedding vector generating the highest generate confidence score value.

Step 512 includes obtaining an answer text associated with the first prior question embedding vector.

Step 514 includes generating a response comprising the identified answer text. In some embodiments, the answer may then be transmitted to the user over a network.

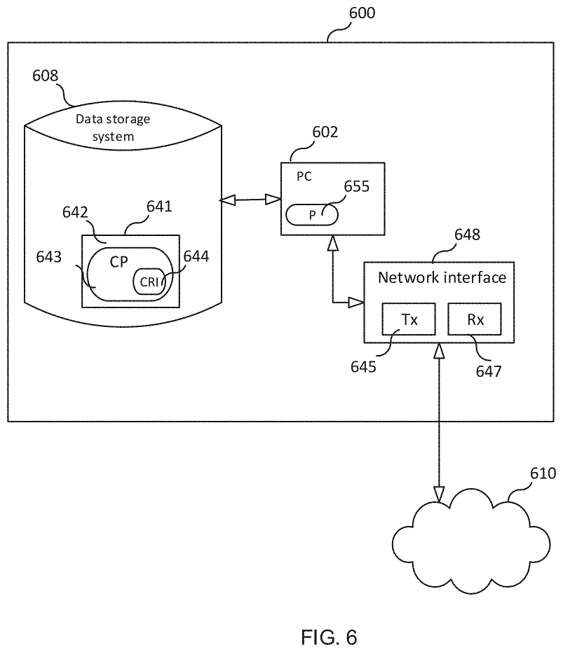

FIG. 6 is a block diagram illustrating a device 600 (e.g., Switchboard System 100), according to some embodiments. As shown in FIG. 6, the device may comprise: processing circuitry (PC) 602, which may include one or more processors (P) 655 (e.g., a general purpose microprocessor and/or one or more other processors, such as an application specific integrated circuit (ASIC), field-programmable gate arrays (FPGAs), and the like); a network interface 1548 comprising a transmitter (Tx) 645 and a receiver (Rx) 647 for enabling the device to transmit data to and receive data from other devices connected to a network 610 (e.g., an Internet Protocol (IP) network or other network) to which network interface 648 is connected; and a local storage unit (a.k.a., “data storage system”) 608, which may include one or more non-volatile storage devices and/or one or more volatile storage devices. In embodiments where PC 602 includes a programmable processor, a computer program product (CPP) 641 may be provided. CPP 641 includes a computer readable medium (CRM) 642 storing a computer program (CP) 643 comprising computer readable instructions (CRI) 644. CRM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes the device to perform steps described herein (e.g., steps described herein with reference to the flow charts). In other embodiments, the device may be configured to perform steps described herein without the need for code. That is, for example, PC 602 may consist merely of one or more ASICs. Hence, the features of the embodiments described herein may be implemented in hardware and/or software.

The following are certain enumerated embodiments further illustrating various aspects of the disclosed subject matter.

A1. A computer-implemented method for clustering and answering questions, the method comprising:

obtaining an input from a user device, wherein the input comprises a text;
transforming, using a first natural language processing model, the text into a first embedding vector representing a location in an embedding graph, wherein the embedding graph comprises a plurality of prior question embedding vectors representing respective locations in the embedding graph and each prior question embedding vector is associated with at least one answer text; selecting a set of prior question embedding vectors based on a distance in the embedding graph between the location of the first embedding vector and the respective locations of the plurality of prior question embedding vectors;
generating, using a zero-shot confidence scoring model, confidence scores value for each prior question embedding vector in the selected set of prior question embedding vectors, wherein the confidence score value corresponds to a degree of similarity between the first embedding vector and each prior question embedding vector in the selected set;
selecting a first prior question embedding vector from the selected set of prior question embedding vectors based on the generated confidence score values;
obtaining an answer text associated with the first prior question embedding vector; and
generating a response comprising the identified answer text.

A2. The method according to item A1, wherein the first natural language processing model is a Bidirectional Encoder Representations from Transformers (BERT) model.

A3. The method according to item A1, further comprising:

transmitting the response towards the user device over a network.

A4. The method according to item A1, further comprising:

outputting the first prior question embedding vector;
obtaining a second input, the second input comprising an indication to use a second prior question embedding vector different than the first prior question embedding vector; and
updating the zero-shot learning model based on the second input.

A5. The method according to item A1, further comprising:

removing a prior question embedding vector from the selected set of prior question embedding vectors based on a filter.

A6. The method according to item A5, further comprising:

receiving a third input from a second user different than the first user comprising the filter.

A7. The method according to item A1, wherein the obtaining the answer text comprises:

determining that the first prior question embedding vector is associated with a first answer text from a first data source and a second answer text from a second data source; and
selecting at least one of the first answer text and the second answer.

A8. The method according to item A1, wherein the input is obtained over a predetermined time frame, and wherein the response is generated within the predetermined time frame.

A9. The method according to item A1, further comprising:

identifying a location of a cluster of prior question embedding vectors nearest to the location of the first embedding vector, wherein the selected set of prior question embedding vectors comprises one or more prior question embedding vectors of the cluster.

A10. The method according to item A9, wherein the selected set of prior embedding vectors comprises a predetermined number of prior question embedding vectors of the cluster.

B1. A device adapted to perform any one of the methods in items A1-A10.

C1. A computer program comprising instructions which when executed by processing circuitry of a device causes the device to perform the method of any one of the items A1-A10.

While various embodiments of the present disclosure are described herein, it should be understood that they have been presented by way of example only, and not limitation. Thus, the breadth and scope of the present disclosure should not be limited by any of the above-described embodiments. Generally, all terms used herein are to be interpreted according to their ordinary meaning in the relevant technical field, unless a different meaning is clearly given and/or is implied from the context in which it is used. All references to a/an/the article, element, device, component, layer, means, step, etc. are to be interpreted openly as referring to at least one instance of the article, element, apparatus, component, layer, means, step, etc., unless explicitly stated otherwise. Any combination of the above-described elements in all possible variations thereof is encompassed by the disclosure unless otherwise indicated herein or otherwise clearly contradicted by context.

### REFERENCES

[1] Jacob Devlin and Ming-Wei Chang, “Open Sourcing BERT: State-of-the-Art Pre-training for Natural Language Processing,” Google AI Language (Nov. 2, 2018), available at https://ai.googleblog.com/2018/11/open-sourcing-bert-state-of-art-pre.html.
[2] Jacob Devlin et al., “BERT: Pre-training of Deep Bidirectional Transformers for Language Understanding,” Google AI Language (May 24, 2019), available at https://arxiv.org/abs/1810.04805.
[3] Alexandre Gonfalonieri, “Applications of Zero-Shot Learning,” towards data science (Sep. 3, 2019), available at https://towardsdatascience.com/applications-of-zero-shot-learning-f65bb232963f.
[4] Timothy Hospedales, “Zero-Shot-Learning,” Youtube (Oct. 23, 2015), available at https://youtu.be/jBnCcr-3bXc.
[5] Transformers, State-of-the-art Natural Language Processing for Jax, Pytorch and Tensorflow, available at https://huggingface.co/transformers/.
[6] The Stanford Natural Language Inference (SNLI) Corpus, available at https://nlp.stanford.edu/projects/snli/.
[7] Nils Reimers, Iryna Gurevych, “Sentence-BERT: Sentence Embeddings using Siamese BERT-Networks,” EMNLP (Aug. 27, 2019), available at https://arxiv.org/abs/1908.10084.
[8] Perspective API, available at https://perspectiveapi.com.

1. A computer-implemented method for clustering and answering questions, the method comprising:
obtaining an input from a user device, wherein the input comprises a text;
transforming, using a first natural language processing model, the text into a first embedding vector representing a location in an embedding graph, wherein the embedding graph comprises a plurality of prior question embedding vectors representing respective locations in the embedding graph and each prior question embedding vector is associated with at least one answer text;
selecting a set of one or more prior question embedding vectors based on a distance in the embedding graph between the location of the first embedding vector and the respective locations of the plurality of prior question embedding vectors;
for each respective prior question embedding vector in the selected set of one or more prior question embedding vectors, generating, using a zero-shot confidence scoring model, a respective confidence score value for the respective prior question embedding vector, wherein the respective confidence score value corresponds to a degree of similarity between the first embedding vector and the respective prior question embedding vector;
selecting a first prior question embedding vector from the selected set of one or more prior question embedding vectors based on the generated respective confidence score value of the first prior question embedding vector;
obtaining an answer text associated with the first prior question embedding vector; and
generating a response comprising the identified answer text.

2. The method of claim 1, wherein the first natural language processing model is a Bidirectional Encoder Representations from Transformers (BERT) model.

3. The method of claim 1, further comprising:
transmitting the response towards the user device over a network.

4. The method of claim 1, further comprising:
outputting the first prior question embedding vector;
obtaining a second input, the second input comprising an indication to use a second prior question embedding vector different than the first prior question embedding vector; and
updating the zero-shot learning model based on the second input.

5. The method of claim 1, further comprising:
removing a prior question embedding vector from the selected set of prior question embedding vectors based on a filter.

6. The method of claim 5, further comprising:
receiving a third input from a second user different than the first user comprising the filter.

7. The method of method of claim 1, wherein the obtaining the answer text comprises:
determining that the first prior question embedding vector is associated with a first answer text from a first data source and a second answer text from a second data source; and
selecting at least one of the first answer text and the second answer.

8. The method of claim 1, wherein the input is obtained over a predetermined time frame, and wherein the response is generated within the predetermined time frame.

9. The method of claim 1, further comprising:
identifying a location of a cluster of prior question embedding vectors nearest to the location of the first embedding vector, wherein the selected set of prior question embedding vectors comprises one or more prior question embedding vectors of the cluster.

10. The method of claim 9, wherein the selected set of prior embedding vectors comprises a predetermined number of prior question embedding vectors of the cluster.

11. A computer program comprising instructions which when executed by processing circuitry of a device causes the device to:
obtain an input from a user device, wherein the input comprises a text;
transform, using a first natural language processing model, the text into a first embedding vector representing a location in an embedding graph, wherein the embedding graph comprises a plurality of prior question embedding vectors representing respective locations in the embedding graph and each prior question embedding vector is associated with at least one answer text;
select a set of one or more prior question embedding vectors based on a distance in the embedding graph between the location of the first embedding vector and the respective locations of the plurality of prior question embedding vectors;
for each respective prior question embedding vector in the selected set of one or more prior question embedding vectors, generate, using a zero-shot confidence scoring model, a respective confidence score value for the respective prior question embedding vector, wherein the respective confidence score value corresponds to a degree of similarity between the first embedding vector and the respective prior question embedding vector;
select a first prior question embedding vector from the selected set of one or more prior question embedding vectors based on the generated respective confidence score value of the first prior question embedding vector;
obtain an answer text associated with the first prior question embedding vector; and
generate a response comprising the identified answer text.

12. A system for clustering and answering questions, the system comprising:
a processor; and
a non-transitory computer readable memory coupled to the processor, wherein the system is configured to:
obtain an input from a user device, wherein the input comprises a text;
transform, using a first natural language processing model, the text into a first embedding vector representing a location in an embedding graph, wherein the embedding graph comprises a plurality of prior question embedding vectors representing respective locations in the embedding graph and each prior question embedding vector is associated with at least one answer text;
select a set of one or more prior question embedding vectors based on a distance in the embedding graph between the location of the first embedding vector and the respective locations of the plurality of prior question embedding vectors;
for each respective prior question embedding vector in the selected set of one or more prior question embedding vectors, generate, using a zero-shot confidence scoring model, a respective confidence score value for the respective prior question embedding vector, wherein the respective confidence score value corresponds to a degree of similarity between the first embedding vector and the respective prior question embedding vector;
select a first prior question embedding vector from the selected set of one or more prior question embedding vectors based on the generated respective confidence score value of the first prior question embedding vector;
obtain an answer text associated with the first prior question embedding vector; and
generate a response comprising the identified answer text.

13. The system of claim 12, wherein the first natural language processing model is a Bidirectional Encoder Representations from Transformers (BERT) model.

14. The system of claim 12, wherein the system is further configured to:
transmit the response towards the user device over a network.

15. The system of claim 12, wherein the system is further configured to:
output the first prior question embedding vector;
obtain a second input, the second input comprising an indication to use a second prior question embedding vector different than the first prior question embedding vector; and
update the zero-shot learning model based on the second input.

16. The system of claim 12, wherein the system is further configured to:
remove a prior question embedding vector from the selected set of prior question embedding vectors based on a filter.

17. The system of claim 16, wherein the system is further configured to:
receive a third input from a second user different than the first user comprising the filter.

18. The system of claim 12, wherein the system is further configured to:
determine that the first prior question embedding vector is associated with a first answer text from a first data source and a second answer text from a second data source; and
select at least one of the first answer text and the second answer.

19. The system of claim 12, wherein the input is obtained over a predetermined time frame, and wherein the response is generated within the predetermined time frame.

20. The system of claim 12, wherein the system is further configured to:
identify a location of a cluster of prior question embedding vectors nearest to the location of the first embedding vector, wherein the selected set of prior question embedding vectors comprises one or more prior question embedding vectors of the cluster.
